(19) United States
(12) Patent Application Publication
(10) Pub. No.: US 2026/0141474 A1
(43) Pub. Date: May 21, 2026

(54) SYSTEMS, METHODS, AND MEDIA FOR SMART CITY CROWD EVACUATION BASED ON INTERNET OF THINGS LARGE MODEL

(71) Applicant: CHENGDU QINCHUAN IOT TECHNOLOGY CO., LTD., Chengdu (CN)

(72) Inventors: Hanshu SHAO, Chengdu (CN); Yong LI, Chengdu (CN); Siwei ZENG, Chengdu (CN)

(73) Assignee: CHENGDU QINCHUAN IOT TECHNOLOGY CO., LTD., Chengdu (CN)

(21) Appl. No.: 19/452,432

(22) Filed: Jan. 19, 2026

(30) Foreign Application Priority Data
Jul. 30, 2025 (CN) 202511052820.X

(51) Int. Cl. G06Q 50/26; G08B 7/06

(52) U.S. Cl. CPC G06Q 50/265; G08B 7/066

(57) ABSTRACT

Systems, methods, and media for smart city crowd evacuation based on an Internet of Things (IoT) large model are provided. The method is executed by an emergency supervision management platform. The method includes: acquiring regional monitoring data based on an emergency supervision sensing control platform through a monitoring device deployed in a monitoring region; determining a regional congestion risk based on the regional monitoring data; in response to the regional congestion risk satisfying an evacuation condition: determining an emergency evacuation parameter based on the regional congestion risk; transmitting an emergency control signal to an emergency evacuation device deployed in the monitoring region via an emergency supervision sensing network platform based on the emergency evacuation parameter, to control an opening interval of a channel gate based on a traffic control parameter, and to control a display content of an electronic display board based on a traffic guidance parameter.

### CROSS-REFERENCE TO RELATED APPLICATIONS

This application claims priority of Chinese Patent Application No. 202511052820.X, filed on Jul. 30, 2025, the entire contents of which are hereby incorporated by reference.

### TECHNICAL FIELD

The present disclosure relates to the field of city crowd evacuation, and in particular to, systems, methods, and media for smart city crowd evacuation based on an Internet of Things (IoT) large model.

### BACKGROUND

With the development of cities, urban population density gradually increases. For large-scale public activity regions with limited space and relatively concentrated crowds, such as scenic spots, squares, passenger stations, or the like, such regions have a risk of stampedes caused by factors such as crowd congestion. Therefore, it is necessary to monitor the pedestrian flow, the personnel density, abnormal crowd behaviors, and abnormal environmental changes in large-scale public activity regions.

To accurately determine pedestrian flow features of different public places at different times, to determine a realistic congestion risk, and further provide a proper evacuation plan, it is necessary to provide a system for smart city crowd evacuation based on an Internet of Things (IoT) large model that can determine an actual regional congestion risk based on regional monitoring data acquired through a monitoring device deployed in a monitoring region, and further transmit an emergency control signal to an emergency evacuation device deployed in the monitoring region to control the emergency evacuation device to perform personnel evacuation.

### SUMMARY

One or more embodiments of the present disclosure provide a system for smart city crowd evacuation based on an Internet of Things (IoT) large model. The system includes an emergency supervision management platform. The emergency supervision management platform is configured to execute a method for smart city crowd evacuation based on the IoT large model.

One or more embodiments of the present disclosure provide a method for smart city crowd evacuation based on an IoT large model. The method is executed by an emergency supervision management platform of a system for smart city crowd evacuation based on an Internet of Things (IoT) large model. The method includes: acquiring regional monitoring data based on an emergency supervision sensing control platform through a monitoring device deployed in a monitoring region; determining a regional congestion risk based on the regional monitoring data, including: determining a regional personnel feature based on the regional monitoring data; determining a regional tolerance based on a regional specification feature and obstacle distribution data; determining first correction data by querying a correction table based on the regional personnel feature; determining an initial regional congestion risk by querying a preset congestion risk table based on the regional tolerance and the regional monitoring data; and determining the regional congestion risk by multiplying the first correction data by the initial regional congestion risk, wherein the initial regional congestion risk is a regional congestion risk before correction, the regional personnel feature includes an age distribution of people in the monitoring region, a count and positions of special groups, and a count and positions of people with luggage, and the special groups include people with mobility impairments and pregnant women; in response to the regional congestion risk satisfying an evacuation condition, determining an emergency evacuation parameter based on the regional congestion risk, including: acquiring a candidate emergency parameter; determining evacuation risk data corresponding to the candidate emergency parameter based on the candidate emergency parameter, the regional congestion risk, the regional specification feature, and the regional personnel feature using an evacuation prediction model, wherein the evacuation risk data refers to a regional congestion risk of the monitoring region at a future time point, on the premise that the candidate emergency parameter is used to evacuate personnel in the monitoring region, and the evacuation prediction model is a machine learning model; and determining the emergency evacuation parameter based on the evacuation risk data, wherein the emergency evacuation parameter includes a device configuration parameter, a traffic control parameter, and a traffic guidance parameter, and the device configuration parameter is used to control a transportation speed of an associated transportation device; and transmitting an emergency control signal to an emergency evacuation device deployed in the monitoring region via an emergency supervision sensing network platform based on the emergency evacuation parameter, to control an opening interval of a channel gate based on the traffic control parameter, and to control a display content of an electronic display board based on the traffic guidance parameter, wherein the display content includes at least one of a display color, an evacuation direction, or an evacuation route.

One or more embodiments of the present disclosure provide a non-transitory computer-readable storage medium. The storage medium stores computer instructions. When the computer instructions in the storage medium are read and executed by a computer, the computer performs the method for smart city crowd evacuation based on the IoT large model.

### BRIEF DESCRIPTION OF THE DRAWINGS

The present disclosure is further described by way of exemplary embodiments. These exemplary embodiments are described in detail with reference to the accompanying drawings. These embodiments are non-limiting exemplary embodiments, in which the same reference numbers represent the same structures, wherein:

FIG. 1 is a schematic diagram illustrating an exemplary structure of a system for smart city crowd evacuation based on an Internet of Things (IoT) large model according to some embodiments of the present disclosure;

FIG. 2 is a flowchart of an exemplary process for smart city crowd evacuation based on an Internet of Things (IoT) large model according to some embodiments of the present disclosure;

FIG. 3 is a schematic diagram illustrating an exemplary process for determining a regional congestion risk according to some embodiments of the present disclosure; and

FIG. 4 is a schematic diagram illustrating an exemplary process for determining an emergency evacuation parameter according to some embodiments of the present disclosure.

### DETAILED DESCRIPTION

To more clearly illustrate the technical solutions in the embodiments of the present disclosure, the drawings used in the description of the embodiments will be briefly introduced below. Obviously, the drawings in the following description are merely some examples or embodiments of the present disclosure. Those skilled in the art, without further creative efforts, may apply the present disclosure to other similar scenarios according to these drawings. Unless obviously obtained from the context or the context illustrates otherwise, the same numeral in the drawings refers to the same structure or operation.

It should be understood that the terms “system”, “device”, “unit” and/or “module” used herein are a method for distinguishing different components, elements, parts, sections or assemblies at different levels. However, if other words can achieve the same purpose, the words can be replaced by other expressions.

As used in the disclosure and the appended claims, the singular forms “a,” “an,” and “the” include plural referents unless the context clearly dictates otherwise; the plural forms may be intended to include singular forms as well. In general, the terms “comprise,” “comprises,” and/or “comprising,” “include,” “includes,” and/or “including” merely prompt to include steps and elements that have been clearly identified, and these steps and elements do not constitute an exclusive listing. The methods or devices may also include other steps or elements.

The present disclosure uses flowcharts to illustrate operations performed by systems according to embodiments of the present disclosure. It should be understood that preceding or following operations are not necessarily performed precisely in sequence. Conversely, each step may be processed in reverse order or simultaneously. Meanwhile, other operations may be added to these processes, or one or more operations may be removed from these processes.

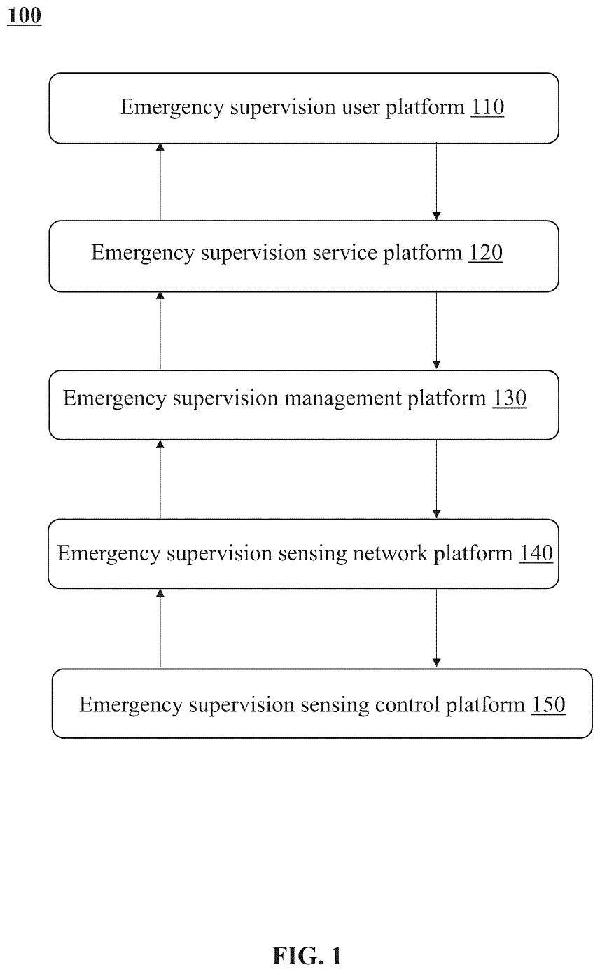

FIG. 1 is a schematic diagram illustrating an exemplary structure of a system for smart city crowd evacuation based on an Internet of Things (IoT) large model according to some embodiments of the present disclosure.

In some embodiments, as shown in FIG. 1, a system for smart city crowd evacuation based on the IoT large model (hereinafter referred to as a system 100) includes an emergency supervision user platform 110, an emergency supervision service platform 120, an emergency supervision management platform 130, an emergency supervision sensing network platform 140, and an emergency supervision sensing control platform 150.

The emergency supervision user platform 110 refers to a platform for comprehensive coordination of emergency management by a superior department.

In some embodiments, the emergency supervision user platform includes a third-party terminal.

The third-party terminal refers to an external terminal device or system software. For example, the third-party terminal is one or any combination of devices with input and/or output functions provided by other institutions, such as mobile devices, computers, etc.

The emergency supervision service platform 120 refers to an interaction and service platform for receiving and transmitting data.

In some embodiments, the emergency supervision service platform 120 interacts upward with the emergency supervision user platform 110 and interacts downward with the emergency supervision management platform 130.

In some embodiments, the emergency supervision service platform 120 is configured with a single server or a server group, a gateway, and a router. The server group is centralized or distributed.

The emergency supervision management platform 130 refers to a comprehensive platform for processing and managing emergency supervision data. The emergency supervision management platform 130 includes a processor, a data center, and a plurality of emergency sub-platforms.

The processor is configured to process information such as acquired emergency supervision data, etc. The processor executes program instructions based on the data, information, and/or processing results to perform one or more functions described in the present disclosure. For example, the processor includes a central processing unit (CPU), a graphics processing unit (GPU), a digital signal processor (DSP), etc., or any combination thereof.

The data center is configured to perform overall management of collected emergency supervision data.

In some embodiments, the data center is configured with a memory.

The memory is configured to store emergency supervision data and/or instructions. The memory includes one or more storage components. Each storage component is an independent device or a part of another device. For example, the memory includes a random-access memory (RAM), a read-only memory (ROM), etc., or any combination thereof.

The emergency sub-platform refers to a sub-platform for supervising the emergency supervision data.

In some embodiments, the emergency supervision management platform 130 is configured to: acquiring regional monitoring data based on an emergency supervision sensing control platform through a monitoring device deployed in a monitoring region; determining a regional congestion risk based on the regional monitoring data; in response to the regional congestion risk satisfying an evacuation condition, determining an emergency evacuation parameter based on the regional congestion risk, wherein the emergency evacuation parameter includes a traffic control parameter and a traffic guidance parameter; transmitting an emergency control signal to an emergency evacuation device deployed in the monitoring region via an emergency supervision sensing network platform based on the emergency evacuation parameter, to control an opening interval of a channel gate based on the traffic control parameter, and to control a display content of an electronic display board based on the traffic guidance parameter. The display content includes at least one of a display color, an evacuation direction, or an evacuation route.

The emergency supervision sensing network platform 140 refers to a management platform for transmitting emergency supervision-related sensing data or information.

In some embodiments, the emergency supervision sensing network platform 140 interacts upward with the data center in the emergency supervision management platform 130 and interacts downward with the emergency supervision sensing control platform.

The emergency supervision sensing network platform 140 includes a plurality of sensing sub-platforms. In some embodiments, each sensing sub-platform is configured to collect sensing data of a region and upload the sensing data to a corresponding emergency sub-platform.

In some embodiments, the emergency supervision sensing network platform 140 includes a communication transmission network and a routing device. The communication transmission network is configured to implement functions of sensing communication of perception information and sensing communication of control information. The routing device is a hardware device configured to implement the sensing communication of information.

The emergency supervision sensing control platform 150 refers to a platform configured to collect emergency supervision data and implement an execution instruction.

In some embodiments, the emergency supervision sensing control platform is configured with a sensor, a memory, and an emergency guidance device.

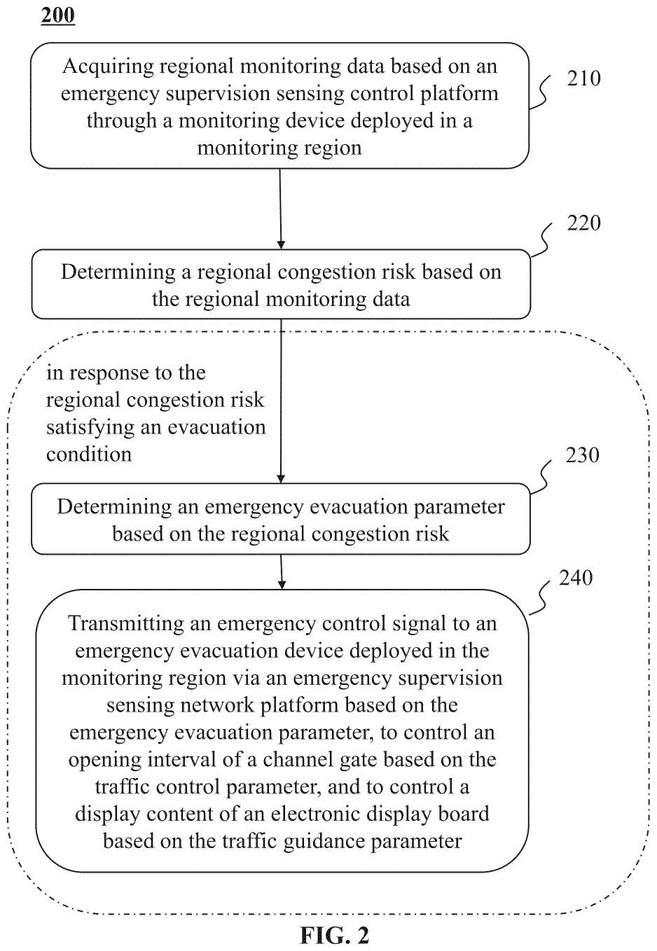

The sensor is a device configured to receive and convert various monitoring information. In some embodiments, the sensor includes a camera and an infrared counter. The camera is configured to acquire monitoring image data. The infrared counter is configured to be installed at a channel entrance/exit and acquire monitoring count data. For more information regarding the monitoring image data and the monitoring count data, please refer to FIG. 2 and related descriptions.

The emergency guidance device is a device configured to provide support in an emergency. In some embodiments, the emergency guidance device includes a gate, an electronic display board, an elevator, an escalator, a broadcast device, or the like.

For more detailed descriptions of the system for smart city crowd evacuation based on the IoT large model, please refer to FIG. 2 to FIG. 4 and the related descriptions.

In some embodiments, the system for smart city crowd evacuation based on the IoT large model can form an information operation closed loop among various functional platforms and operate in a coordinated and regular manner. The system for smart city crowd evacuation based on the IoT large model can efficiently and accurately determine the actual emergency control scope to improve the processing efficiency of an emergency event.

FIG. 2 is a flowchart of an exemplary process for smart city crowd evacuation based on an Internet of Things (IoT) large model according to some embodiments of the present disclosure. As shown in FIG. 2, a process 200 includes the following operations. In some embodiments, the process 200 is performed by the emergency supervision management platform.

In 210, regional monitoring data is acquired based on an emergency supervision sensing control platform through a monitoring device deployed in a monitoring region.

In some embodiments, an application scenario of the present case is a place with a plurality of entrances/exits, such as a subway station or a large stadium.

In some embodiments, a place includes a plurality of monitoring regions, and the plurality of monitoring regions are interconnected. For example, the monitoring regions are directly connected or connected via a passage, an entrance/exit.

In some embodiments, the plurality of monitoring regions are a plurality of regions naturally formed in the place due to the existence of buildings. For example, the monitoring region is a waiting hall A of a station, a waiting hall B of a station, or the like.

In some embodiments, the plurality of monitoring regions refer to a plurality of regions formed after the self-division of regions in the place. For example, the monitoring region is a northeast corner, a southeast corner, a southwest corner, and a northwest corner of the waiting hall A, or the like.

In some embodiments, a place corresponds to a monitoring region, and different functional regions or different location regions in the monitoring region correspond to different sub-regions in the monitoring region. A division manner of the sub-regions is preset, for example, the division manner may be a manner based on unit space division, or the like.

For ease of description, the following takes a place that includes a plurality of monitoring regions as an example.

The monitoring device refers to a device arranged in the monitoring region to perform a monitoring function. For example, the monitoring device is a video analysis camera, an infrared/thermal imaging camera, an acoustic sensor, a smart gate, a face recognition device, an infrared counter, or the like.

The regional monitoring data refers to monitoring data of an entire monitoring region acquired by the monitoring device.

In some embodiments, the regional monitoring data includes monitoring image data, monitoring count data, or the like.

In some embodiments, the regional monitoring data of the plurality of monitoring regions constitutes monitoring data of the entire place.

In some embodiments, the regional monitoring data is obtained via the monitoring device arranged in the monitoring region.

In 220, a regional congestion risk based on the regional monitoring data is determined.

The regional congestion risk refers to a risk of events such as safety accidents, public disorder, or health hazards occurring in the monitoring region due to factors including excessively high personnel density, inefficient crowd flow, or inadequate management. For example, the regional congestion risk includes a risk of a stampede accident risk, a risk of an evacuation failure risk, or the like.

In some embodiments, the emergency supervision management platform is configured to obtain a pedestrian flow feature based on the regional monitoring data, determine a personnel density feature of the monitoring region based on the pedestrian flow feature and a region area, and then determine the regional congestion risk.

The pedestrian flow feature refers to a feature related to pedestrian flow in the monitoring region. For example, a personnel quantity, a pedestrian flow, a personnel movement mode, or the like. Pedestrian flow features of a plurality of regions in the monitoring region are calculated separately.

In some embodiments, the emergency supervision management platform is configured to obtain the pedestrian flow and the personnel quantity using monitoring count data, and then determine a pedestrian movement direction using an image recognition algorithm or an image recognition model based on monitoring image data. The image recognition algorithm includes a Haar feature cascade algorithm, a Support Vector Machine (SVM) algorithm, or the like. The image recognition model includes YOLO, a Gaussian Mixture Model (GMM), or the like.

The personnel density feature refers to a feature that quantifies and characterizes dynamic attributes of crowd distribution in the monitoring region. The personnel density feature is used to describe, evaluate, and predict the regional congestion risk. For example, the personnel density feature is the personnel density in the region, the personnel density distribution in the region, or the like.

In some embodiments, the emergency supervision management platform is configured to determine the personnel density distribution by processing the pedestrian flow feature and the region area using a clustering algorithm. For example, the emergency supervision management platform is configured to cluster personnel in the monitoring region using the clustering algorithm based on personnel position coordinates to obtain a plurality of clusters. Each cluster includes a crowd coordinate range of a plurality of regions in the monitoring region (e.g., cluster 1 covers a crowd coordinate range from exit A to a region of gate B). The clustering algorithm includes the DBSCAN algorithm, or the like.

In some embodiments, the personnel density distribution includes a cluster density and a cluster radius of the personnel distribution.

The cluster density of the personnel distribution refers to a ratio of a total count of personnel in the cluster to the area covered by the cluster.

The cluster radius of the personnel distribution refers to a distance between the two farthest points within the area covered by the cluster, and the cluster radius of the personnel distribution can reflect the looseness degree of the crowd distribution.

In some embodiments, the greater the personnel density feature of the monitoring region, the higher the regional congestion risk.

In some embodiments, in response to a quantity of clusters whose cluster density is greater than a density threshold being large (e.g., the quantity of clusters is greater than a quantity threshold), the emergency supervision management platform is configured to generate broadcast audio to prompt personnel not to gather in crowds. The density threshold can be preset manually based on prior experience.

In some embodiments, the emergency supervision management platform is configured to display the cluster density in the form of a heat map on a map interface, e.g., red represents a high risk, and green represents a low risk. The heat map marked with red and green is displayed to staff, and the staff perform broadcast intervention or remind personnel not to gather or crowd.

In some embodiments, the emergency supervision management platform is further configured to determine the regional congestion risk based on the following relationship, wherein the relationship is: the greater the personnel density of the plurality of regions in the monitoring region and the greater the quantity of clusters whose cluster density is greater than the density threshold, the greater the regional congestion risk.

In 230, in response to the regional congestion risk satisfying an evacuation condition, the emergency evacuation parameter is determined based on the regional congestion risk.

In some embodiments, the emergency evacuation parameter includes a traffic control parameter and a traffic guidance parameter.

The evacuation condition includes the regional congestion risk being higher than a preset risk threshold.

In some embodiments, the preset risk threshold is preset manually based on prior experience.

The traffic control parameter refers to a control parameter of a traffic-related device. For example, the traffic control parameter includes an opening interval of a channel gate at an entrance or exit, or the like.

The channel gate refers to a gate in a channel within the monitoring region. For example, the channel gate is an entrance or exit gate at subway station C.

The opening interval refers to a duration for which the channel gate in the monitoring region remains open.

The traffic guidance parameter refers to a control parameter of an indication device (e.g., an electronic display board). For example, the traffic guidance parameter includes a display content of the electronic display board.

The electronic display board refers to a display board disposed in the monitoring region to provide indication information to a crowd. For example, the electronic display board is an LED light board, or the like.

The display content includes at least one of a display color, an evacuation direction, and an evacuation route.

The display color refers to a color displayed by the electronic display board. For example, red represents a high emergency level, and green represents a low emergency level.

The evacuation direction refers to a direction in which personnel are guided to move, for example, the evacuation direction includes a direction of a destination of an evacuation route.

The evacuation route refers to a route for guiding personnel to evacuate to a destination.

In some embodiments, the emergency supervision management platform is configured to generate the evacuation route using a path planning algorithm. The path planning algorithm includes Dijkstra, an A* algorithm, or the like.

In some embodiments, the evacuation route includes a plurality of routes respectively leading to different low-risk regions (if a plurality of low-risk regions exist). A starting point of the evacuation route is the region center of a current monitoring region. A description of the low-risk region is provided later.

For example, passengers on the current subway train are concentrated in the front and rear sections of the carriage, while the middle section is relatively empty. When passengers in the front and rear sections exit the train, electronic instructions can be generated and displayed on electronic display boards to guide them to take the escalators corresponding to the middle section of the carriage.

In some embodiments, the emergency supervision management platform is configured to determine the emergency evacuation parameter based on the regional congestion risk.

In some embodiments, the emergency supervision management platform is configured to determine the traffic control parameter based on the regional congestion risk of the monitoring region according to a preset table. For example, the higher the regional congestion risk of the monitoring region, the shorter the opening interval of a channel gate at an entrance corresponding to the monitoring region, and the longer the opening interval of a channel gate at an exit corresponding to the monitoring region. The channel gate at the entrance and the channel gate at the exit corresponding to the monitoring region are adjusted by the emergency supervision management platform. Meanwhile, the emergency supervision management platform is configured to display a region with a lower regional congestion risk and a route to the region on the electronic display board.

In some embodiments, the preset table is preset manually based on prior experience.

In some embodiments, the emergency supervision management platform is further configured to determine a similar region of the monitoring region based on region function data, region layout feature, and region object data; determine the emergency evacuation parameter based on the similar region and the regional congestion risk.

The region function data refers to information describing a function of the region. The region function data includes the region type of the monitoring region, a related function of the monitoring region, etc.

In some embodiments, in response to a determination that a place type corresponding to the monitoring region is different, the region type of the monitoring region is different. For example, in response to a determination that the place type is a subway station, the region type of the monitoring region includes a rest area, a transportation area, a personnel passage area, etc.

In some embodiments, the related function of the monitoring region is determined based on a corresponding region type. For example, a function of the monitoring region corresponding to the rest area includes providing a rest place.

The region layout feature refers to a feature describing the layout information of a plurality of functional devices and equipment in the monitoring region. For example, the region layout feature includes the quantity of functional devices and equipment in the monitoring region, a distribution situation, etc. The functional devices and equipment include a seat, an information screen, a channel gate, etc. The distribution situation includes a distribution density, etc.

In some embodiments, the distribution situation of the functional devices and equipment in the monitoring region is obtained by calculating coordinates in a floor plan.

The similar region of the monitoring region refers to a region where a region similarity with the monitoring region satisfies a preset similarity condition. The region similarity refers to an indicator for quantifying a matching degree of a plurality of monitoring regions in function, layout, and risk features. The preset similarity condition includes that the region similarity is greater than a preset threshold, etc.

In some embodiments, the emergency supervision management platform is configured to construct region feature vectors based on the region function data and the region layout feature of each monitoring region. The emergency supervision management platform is configured to perform clustering on the region feature vectors of all monitoring regions using a clustering algorithm to obtain a plurality of clusters. A region similarity between monitoring regions in the same cluster satisfies the preset similarity condition by default, i.e., the monitoring regions in the same cluster are similar to each other.

In some embodiments, the clustering algorithm includes K-means, DBSCAN, etc.

In some embodiments, the emergency supervision management platform is configured to determine a monitoring region with a regional congestion risk lower than a first risk threshold as a low-risk region, and determine a monitoring region with a regional congestion risk greater than a second risk threshold as a high-risk region. When determining the traffic control parameter and the traffic guidance parameter of the emergency evacuation parameter, a low-risk region in a similar region of the high-risk region is designated as an end point of its evacuation route and displayed on the electronic display board. Meanwhile, the system may control and increase the opening intervals of the channel gates at the entrances and exits along the evacuation routes.

By adjusting the evacuation routes based on region similarity and the regional evacuation risk, the trial-and-error cost can be reduced, and the robustness and adaptability of the system for smart city crowd evacuation based on the IoT large model can be enhanced.

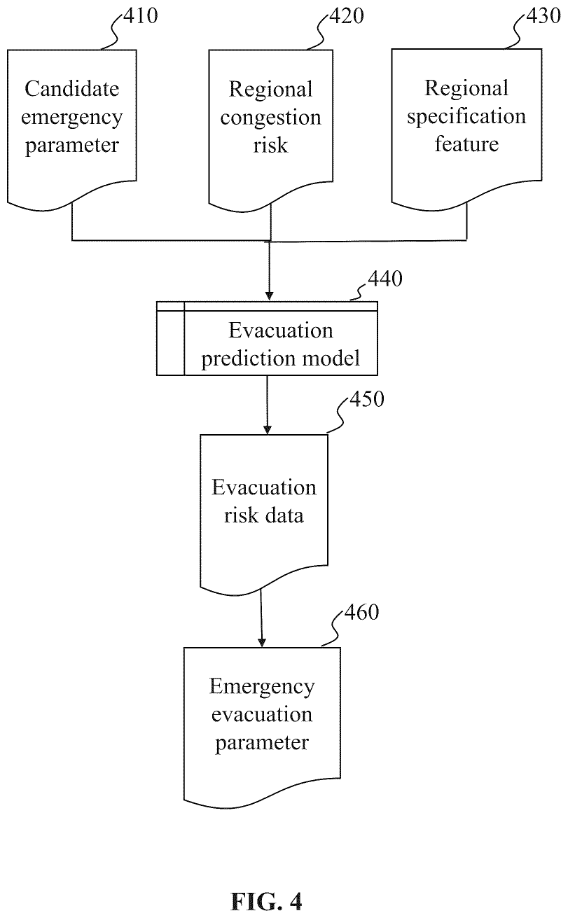

For more descriptions on determining the emergency evacuation parameter, please refer to FIG. 4 and related descriptions.

In some embodiments, the emergency evacuation parameter further includes the device configuration parameter.

The device configuration parameter refers to a related parameter for controlling the associated transportation device. For example, the device configuration parameter includes a transportation speed of the associated transportation device.

In some embodiments, the emergency supervision management platform is further configured to control the transportation speed of the associated transportation device based on the device configuration parameter.

The associated transportation device refers to a transportation device deployed in the monitoring region or a transportation device required for entering and exiting the monitoring region. For example, the associated transportation device includes a moving walkway in an airport.

The transportation speed refers to a speed at which the associated transportation device performs transportation. For example, the transportation speed refers to a transportation speed of the moving walkway in the airport.

In some embodiments, the emergency supervision management platform is configured to control the transportation speed of the associated transportation device based on the regional congestion risk by querying a congestion risk-transportation speed table. For example, the higher the regional congestion risk, the faster the transportation speed of the device in a corresponding monitoring region (on the premise that a safe speed upper limit is not exceeded).

In some embodiments, the congestion risk-transportation speed table is preset manually based on prior experience.

In some embodiments, based on controlling the transportation speed of the associated transportation device according to the regional congestion risk, the transportation speed of the associated transportation device can be adjusted in real time to realize active regulation of crowd flow, thereby ensuring personnel safety while improving overall traffic efficiency

In 240, based on the emergency evacuation parameter, an emergency control signal is transmitted to an emergency evacuation device deployed in the monitoring region through the emergency supervision sensing network platform, so as to control an opening interval of the channel gate based on the traffic control parameter, and control a display content of the electronic display board based on the traffic guidance parameter.

The emergency evacuation device refers to a device that performs emergency evacuation in the monitoring region. For example, the emergency evacuation device includes a channel gate, an electronic display board, a transportation device, etc.

The emergency control signal refers to a signal for controlling the emergency evacuation device to perform emergency evacuation.

In some embodiments, the emergency supervision management platform is configured to control the channel gate and the electronic display board based on the emergency control signal. Meanwhile, the emergency supervision management platform is configured to send corresponding evacuation prompt information to a user terminal through the emergency supervision user platform.

According to some embodiments of the present disclosure, based on the regional monitoring data acquired by the monitoring devices deployed in the monitoring region, the actual regional congestion risk can be accurately determined, achieving real-time and precise risk perception and early warning. Meanwhile, based on the actual regional congestion risk, an emergency evacuation parameter can be determined, and a corresponding emergency control signal can be transmitted to an emergency evacuation device deployed in the monitoring region to control the emergency evacuation device to perform personnel evacuation operations. This approach can reduce the accident rate, improve evacuation efficiency, and significantly enhance public safety benefits.

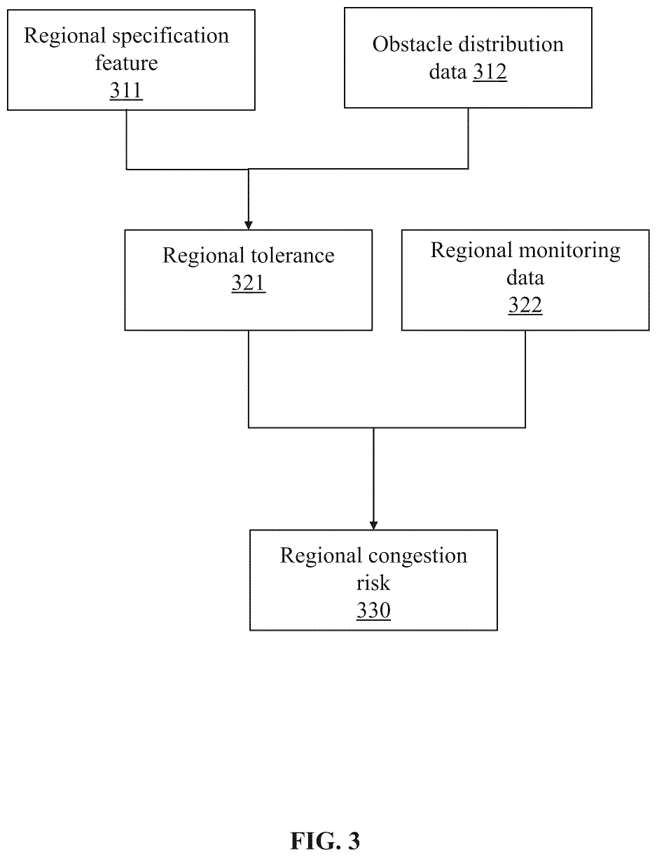

FIG. 3 is a schematic diagram illustrating an exemplary process for determining a regional congestion risk according to some embodiments of the present disclosure.

In some embodiments, the emergency supervision management platform 130 determines the regional tolerance 321 based on the regional specification feature 311 and obstacle distribution data 312; and determines the regional congestion risk 330 based on the regional tolerance 321 and regional monitoring data 322.

For more information about the regional monitoring data 322 and the regional congestion risk 330, please refer to FIG. 2 and related descriptions.

The regional specification feature refers to a parameter describing a dimensional specification of the monitoring region. In some embodiments, the regional specification feature includes a shape and an area of the monitoring region. The regional specification feature is obtained and characterized through a floor plan of the monitoring region.

In some embodiments, the regional specification feature is obtained through user input.

The obstacle distribution data refers to a parameter describing a distribution of obstacles in the monitoring region. In some embodiments, the obstacle distribution data includes sizes of a plurality of obstacles in the monitoring region and the position coordinates of the obstacles.

In some embodiments, the emergency supervision management platform determines the obstacle distribution data based on monitoring image data in the regional monitoring data. For example, the emergency supervision management platform identifies the monitoring image data in the regional monitoring data by an image recognition algorithm or an image recognition model to obtain the obstacle distribution data. For more information about the image recognition algorithm or the image recognition model, please refer to FIG. 2 and related descriptions.

The regional tolerance refers to a parameter measuring the bearing capacity of a region for a congestion risk. In some embodiments, the larger the regional tolerance of the region, the more prone the region is to congestion. In some embodiments, when the count of people in the region is the same, the larger the regional tolerance, the more severe the congestion condition in the region.

The emergency supervision management platform determines the regional tolerance based on the regional specification feature and the obstacle distribution data. In some embodiments, the emergency supervision management platform constructs a tolerance feature vector based on the regional specification feature, the obstacle distribution data, and a region type, and determines the regional tolerance by retrieving a vector database based on the tolerance feature vector. The region type refers to a type of a certain region in the monitoring region, e.g., a waiting area of a railway station, a security check area, or the like. The vector database includes a plurality of sets of reference tolerance feature vectors and corresponding reference regional tolerances. The vector database is constructed based on historical data or experimental data.

For example, the emergency supervision management platform takes the regional specification feature, the obstacle distribution data, and the region type from historical data (e.g., data extracted from historical data of existing smart city construction cases such as subway stations, shopping malls, railway stations, etc.) or experimental data as a reference tolerance feature vector. Then, the emergency supervision management platform normalizes an actual congestion condition (e.g., an evacuation time, a count of complaints, etc.), a pedestrian flow density, and a change rate of pedestrian flow density from the historical data or the experimental data, respectively, and performs a weighted summation to generate the corresponding regional tolerance. The weights for the weighted summation are preset.

The emergency supervision management platform determines the regional congestion risk in various ways based on the regional tolerance and the regional monitoring data.

In some embodiments, the emergency supervision management platform determines the regional congestion risk by querying a preset congestion risk table based on the regional tolerance and the regional monitoring data. The preset congestion risk table is preset based on historical data or experience.

In some embodiments, the larger the personnel density and the count of target clusters in the regional monitoring data corresponding to the monitoring region, the lower the regional tolerance, and the larger the regional congestion risk. The target cluster refers to a cluster with a cluster density greater than a density threshold. The density threshold is set based on experience. For more information about the cluster density, please refer to FIG. 2 and related descriptions.

In some embodiments, the emergency supervision management platform determines a regional personnel feature based on the regional monitoring data; and determines the regional congestion risk based on the regional personnel feature, the regional tolerance, and the regional monitoring data.

The regional personnel feature is a parameter used to describe the features of people present in the region. In some embodiments, the regional personnel feature includes an age distribution of people in the region, a count and positions of special groups, and a count and positions of people with luggage. The special groups include people with mobility impairments, pregnant women, or the like.

In some embodiments, the emergency supervision management platform identifies and obtains the regional personnel feature using an image recognition algorithm or an image recognition model based on the regional monitoring data. For more descriptions about the image recognition algorithm or the image recognition model, please refer to FIG. 2 and related descriptions.

The emergency supervision management platform determines the regional congestion risk based on the regional personnel feature, the regional tolerance, and the regional monitoring data. In some embodiments, the emergency supervision management platform determines first correction data by querying a correction table based on the regional personnel feature; determine an initial regional congestion risk by querying the preset congestion risk table based on the regional tolerance and the regional monitoring data; and determine the regional congestion risk based on a relationship that the regional congestion risk is equal to a product of the first correction data and the initial regional congestion risk. The initial regional congestion risk is the regional congestion risk before correction.

The first correction data includes a first correction amplitude. The first correction amplitude refers to a coefficient for correcting the initial regional congestion risk. The correction table includes an age distribution of regional personnel, a proportion of special groups, and corresponding correction amplitudes. The correction table is constructed based on historical data or experimental data. For example, the higher the proportion of elderly people in the age distribution of the regional personnel and the proportion of special groups, the larger the correction amplitude and the larger the corrected regional congestion risk. In some embodiments, the correction amplitude is greater than 1.

In some embodiments, by considering the regional personnel feature to appropriately correct the regional congestion risk, the determined regional congestion risk can better fit the actual situation and is more accurate.

In some embodiments, the emergency supervision management platform determines predicted pedestrian flow data at a future time point based on the regional monitoring data, the regional specification feature, and external environmental data through a feature prediction model; determines predicted risk data based on the predicted pedestrian flow data; and determine an updated regional congestion risk based on the predicted risk data and the regional tolerance.

The external environmental data is data used to describe an external environment of the monitoring region at a current time point. In some embodiments, the external environmental data includes the rainfall, temperature, weather type of a certain region, or the like.

In some embodiments, the external environmental data is obtained from a third-party platform.

The predicted pedestrian flow data is a pedestrian flow feature of a certain region at a future time point. For more details regarding the pedestrian flow feature, please refer to FIG. 2 and the related description.

In some embodiments, the emergency supervision management platform is configured to determine the predicted pedestrian flow data at a future time point based on the regional monitoring data, the regional specification feature, and the external environmental data using a feature prediction model.

The feature prediction model refers to a model configured to predict the predicted pedestrian flow data at future time points. The feature prediction model is a machine learning model. Merely by way of example, the feature prediction model includes one or a combination of a Deep Neural Network (DNN) model or other customized models.

An input of the feature prediction model includes the regional monitoring data, the regional specification feature, and the external environmental data. An output of the feature prediction model includes the predicted pedestrian flow data at the future time point.

In some embodiments, the emergency supervision management platform is configured to determine the predicted pedestrian flow data at the future time point based on a regional personnel feature, the regional monitoring data, the regional specification feature, and the external environmental data using the feature prediction model. For more description regarding the regional personnel feature, please refer to the related description above.

In some embodiments, crowd activity behaviors vary in different regions. By taking into account the current regional personnel feature, the predicted pedestrian flow data at the future time point can be determined more accurately.

In some embodiments, the feature prediction model is obtained by training an initial feature prediction model using a plurality of sets of first training samples with first labels. The first training sample includes sample regional monitoring data, a sample regional specification feature, and sample external environmental data of a sample region at a first historical time point. A first label includes an actual pedestrian flow feature of the sample region at a second historical time point. The first historical time point precedes the second historical time point. The sample region includes one or more sample monitoring regions.

In some embodiments, the first training samples and the first labels are obtained based on historical data.

In some embodiments, the emergency supervision management platform is configured to input a plurality of first training samples with the first labels into the initial feature prediction model, construct a loss function based on the first labels and results from the initial feature prediction model, and iteratively update parameters of the initial feature prediction model based on the loss function via gradient descent or other ways. When a preset condition is satisfied, model training is complete, resulting in the trained feature prediction model. The preset condition includes the loss function converging, an iteration count reaching a threshold, etc.

The predicted risk data refers to data describing a regional congestion risk of a region at the future time point.

In some embodiments, the emergency supervision management platform is configured to determine the regional congestion risk at the future time point based on the pedestrian flow data at the future time point, and use the regional congestion risk at the future time point as the predicted risk data. For more details on determining the regional congestion risk based on the pedestrian flow data, please refer to operation 220 of FIG. 2 and the related description.

In some embodiments, the emergency supervision management platform is configured to determine an updated regional congestion risk based on the predicted risk data and a regional tolerance. For example, the emergency supervision management platform obtains a risk growth amplitude based on a difference between the predicted risk data and a current regional congestion risk. In response to the risk growth amplitude exceeding a risk threshold, the emergency supervision management platform determines the regional congestion risk based on the regional personnel feature, the regional tolerance, and the regional monitoring data; determines second correction data based on the risk growth amplitude; and determines the updated regional congestion risk based on a relationship that the updated regional congestion risk is equal to a product of the second correction data and the regional congestion risk. The second correction data includes the second correction amplitude. The second correction amplitude refers to a coefficient for correcting the regional congestion risk. For more details on determining the regional congestion risk based on the regional personnel feature, the regional tolerance, and the regional monitoring data, please refer to the related description above.

The risk growth amplitude is positively correlated with the correction data. The risk threshold is preset based on experience.

In some embodiments, by taking into account the predicted pedestrian flow data and the predicted risk data at the future time point, the accuracy of regional congestion risk early warning is improved, and the optimal allocation of control resources is realized.

In some embodiments, by comprehensively analyzing the regional specification feature, obstacle distribution data, and real-time regional monitoring data, and dynamically quantifying the regional load capacity threshold and the level of the regional congestion risk, accurate prediction and hierarchical early warning of the pedestrian congestion risk are achieved, which effectively improves the scientificity of public space safety management and the capability of risk prediction.

FIG. 4 is a schematic diagram illustrating an exemplary process for determining an emergency evacuation parameter according to some embodiments of the present disclosure.

In some embodiments, the emergency supervision management platform is further configured to acquire a candidate emergency parameter 410; determine evacuation risk data 450 corresponding to the candidate emergency parameter 410 based on a candidate emergency parameter 410, a regional congestion risk 420, and a regional specification feature 430 through an evacuation prediction model 440; and determine an emergency evacuation parameter 460 based on the evacuation risk data 450. The evacuation prediction model 440 is a machine learning model.

The candidate emergency parameter refers to a candidate emergency evacuation parameter.

In some embodiments, the emergency supervision management platform is configured to determine a parameter range for the emergency evacuation parameter of a monitoring region based on the regional congestion risk of the monitoring region, and randomly generate a candidate emergency parameter within the parameter range.

For example, different candidate emergency parameters include opening intervals of entrance/exit channel gates adjusted by different amplitudes, and different evacuation routes generated based on different evacuation directions. Parameter ranges corresponding to the emergency evacuation parameters vary with the regional congestion risks. For example, the higher the regional congestion risk, the shorter the opening interval of the entrance channel gate, the longer the opening interval of the exit channel gate, and the greater the count of corresponding evacuation directions and/or guidance routes. In addition, the evacuation destination shall be a monitored region with lower regional congestion risk (e.g., lower than the regional congestion risk of the departure place) and higher region similarity (e.g., the region similarity is higher than the preset threshold).

In some embodiments, the planning of the evacuation route is comprehensively determined based on the regional congestion risks of all monitoring regions within the entire place. For example, the evacuation routes may be formulated by taking the monitoring regions with high regional congestion risks as the departure points and the monitoring regions with low regional congestion risks as the destinations, following the principle that the regional congestion risks of the passing monitoring regions are preferably not higher than that of the departure point. The system performs overall planning for each monitoring region with high regional congestion risk by adopting path planning algorithms such as Dijkstra and A* algorithms.

The regional specification feature refers to a feature describing a physical spatial attribute of the monitoring region. For example, the regional specification feature includes an area of the monitoring region.

The evacuation prediction model refers to a model configured to determine the evacuation risk data corresponding to the candidate emergency parameter. In some embodiments, the evacuation prediction model is a machine learning model. For example, the machine learning model includes a deep neural network (DNN) model, or the like.

An input of the evacuation prediction model includes the candidate emergency parameter, current and historical regional congestion risks of the monitoring region, the regional specification feature, current and historical regional monitoring data, current and historical pedestrian flow features, and emergency device data. For more details regarding the regional congestion risk, the regional monitoring data, and the pedestrian flow feature, please refer to FIG. 2 and its related descriptions.

The emergency device data refers to data related to the emergency evacuation device, e.g., a type, a quantity, a distribution within the monitoring region, etc., of the emergency evacuation device.

An output of the evacuation prediction model includes the evacuation risk data corresponding to the candidate emergency parameter.

The evacuation risk data refers to a regional congestion risk of the monitoring region at the future time point, on the premise that the candidate emergency parameter is used to evacuate personnel in the monitoring region.

In some embodiments, the input of the evacuation prediction model further includes the regional personnel feature.

For more details regarding the regional personnel feature, please refer to FIG. 3 and its related descriptions.

By incorporating the regional personnel feature, the evacuation prediction model can more accurately capture the dynamics and diversity of crowd behavior, thereby generating more scientific emergency evacuation parameters. The synergistic effect of the multi-dimensional input of the evacuation prediction model not only improves prediction accuracy but also enhances the adaptability of the system to complex scenarios, providing strong technical support for urban emergency management.

A training method of the evacuation prediction model is the same as a training method of the feature prediction model. For more information on the training way of the feature prediction model, please refer to the related content of FIG. 3 above.

In some embodiments, second training samples and second labels are obtained based on historical data.

In some embodiments, the second training sample includes a sample emergency parameter, a regional congestion risk of a sample region at a first time point, a regional congestion risk of the sample region at a second time point, a regional specification feature of the sample region, regional monitoring data of the sample region at the first time point, regional monitoring data of the sample region at the second time point, a pedestrian flow feature of the sample region at the first time point, a pedestrian flow feature of the sample region at the second time point, and emergency device data of the sample region.

In some embodiments, a second training label is an actual regional congestion risk of the sample region at a third time point, and is determined based on historical data, such as based on regional monitoring data of the sample region at the third time point. The first time point, the second time point, and the third time point are all historical time points. The first time point is before the second time point, and the second time point is before the third time point.

In some embodiments, the emergency supervision management platform determines a candidate emergency parameter whose corresponding evacuation risk data is lower than a second risk threshold as the emergency evacuation parameter.

In some embodiments, the emergency supervision management platform determines a candidate emergency parameter whose corresponding evacuation risk data is the smallest as the emergency evacuation parameter.

In some embodiments, the future time point includes a plurality of future time points. The emergency supervision management platform performs a weighted calculation on regional congestion risks of all the future time points included in the evacuation risk data, and selects a candidate emergency parameter corresponding to the evacuation risk data with the smallest weighted value as the emergency evacuation parameter. The closer the future time point is to the current time point, the higher the weight assigned to its corresponding regional congestion risk.

In some embodiments, determining emergency evacuation parameters based on historical parameters via the evacuation prediction model enables rapid identification of high-value options from the historical parameters, thereby improving decision-making efficiency. In addition, the application of the evacuation prediction model enhances the accuracy of risk prediction, achieving precise risk prevention and control.

The basic concepts have been described above, apparently, in detail, as will be described above, and do not constitute limitations of the disclosure. Although there is no clear explanation here, those skilled in the art may make various modifications, improvements, and improvements to the present disclosure. This type of modification, improvement, and correction is recommended in the present disclosure, so the modification, improvement, and amendment remain in the spirit and scope of the exemplary embodiment of the present disclosure.

What is claimed is:

1. A system for smart city crowd evacuation based on an Internet of Things (IoT) large model, comprising: an emergency supervision management platform configured to:
acquire regional monitoring data based on an emergency supervision sensing control platform through a monitoring device deployed in a monitoring region;
determine a regional congestion risk based on the regional monitoring data, including: determining a regional personnel feature based on the regional monitoring data; determining a regional tolerance based on a regional specification feature and obstacle distribution data; determining first correction data by querying a correction table based on the regional personnel feature; determining an initial regional congestion risk by querying a preset congestion risk table based on the regional tolerance and the regional monitoring data; and determining the regional congestion risk by multiplying the first correction data by the initial regional congestion risk, wherein the initial regional congestion risk is a regional congestion risk before correction, the regional personnel feature includes an age distribution of people in the monitoring region, a count and positions of special groups, and a count and positions of people with luggage, and the special groups include people with mobility impairments and pregnant women;
in response to the regional congestion risk satisfying an evacuation condition, determine an emergency evacuation parameter based on the regional congestion risk, including: acquiring a candidate emergency parameter; determining evacuation risk data corresponding to the candidate emergency parameter based on the candidate emergency parameter, the regional congestion risk, the regional specification feature, and the regional personnel feature using an evacuation prediction model, wherein the evacuation risk data refers to a regional congestion risk of the monitoring region at a future time point, on the premise that the candidate emergency parameter is used to evacuate personnel in the monitoring region, and the evacuation prediction model is a machine learning model; and determining the emergency evacuation parameter based on the evacuation risk data, wherein the emergency evacuation parameter includes a device configuration parameter, a traffic control parameter, and a traffic guidance parameter, and the device configuration parameter is used to control a transportation speed of an associated transportation device; and
transmit an emergency control signal to an emergency evacuation device deployed in the monitoring region via an emergency supervision sensing network platform based on the emergency evacuation parameter, to control an opening interval of a channel gate based on the traffic control parameter, and to control a display content of an electronic display board based on the traffic guidance parameter, wherein the display content includes at least one of a display color, an evacuation direction, or an evacuation route.

2. The system according to claim 1, wherein the emergency supervision management platform is further configured to:
determine predicted pedestrian flow data at the future time point based on the regional monitoring data, the regional specification feature, and external environmental data using a feature prediction model, wherein the feature prediction model is a machine learning model;
determine predicted risk data based on the predicted pedestrian flow data; and
determine an updated regional congestion risk based on the predicted risk data and a regional tolerance.

3. The system according to claim 2, wherein the emergency supervision management platform is further configured to:
determine the predicted pedestrian flow data at the future time point based on the regional personnel feature, the regional monitoring data, the regional specification feature, and the external environmental data using the feature prediction model.

4. The system according to claim 1, wherein the emergency supervision management platform is further configured to:
determine a similar region of the monitoring region based on region function data, a region layout feature, and region object data; and
determine the emergency evacuation parameter based on the similar region and the regional congestion risk.

5. The system according to claim 1, wherein an input of the evacuation prediction model includes the regional personnel feature.

6. A method for smart city crowd evacuation based on an Internet of Things (IoT) large model, wherein the method is executed by an emergency supervision management platform for smart city crowd evacuation based on the IoT large model, and the method comprises:
acquiring regional monitoring data based on an emergency supervision sensing control platform through a monitoring device deployed in a monitoring region;
determining a regional congestion risk based on the regional monitoring data, including: determining a regional personnel feature based on the regional monitoring data; determining a regional tolerance based on a regional specification feature and obstacle distribution data; determining first correction data by querying a correction table based on the regional personnel feature; determining an initial regional congestion risk by querying a preset congestion risk table based on the regional tolerance and the regional monitoring data; and determining the regional congestion risk by multiplying the first correction data by the initial regional congestion risk, wherein the initial regional congestion risk is a regional congestion risk before correction, the regional personnel feature includes an age distribution of people in the monitoring region, a count and positions of special groups, and a count and positions of people with luggage, and the special groups include people with mobility impairments and pregnant women;
in response to the regional congestion risk satisfying an evacuation condition, determining an emergency evacuation parameter based on the regional congestion risk, including: acquiring a candidate emergency parameter; determining evacuation risk data corresponding to the candidate emergency parameter based on the candidate emergency parameter, the regional congestion risk, the regional specification feature, and the regional personnel feature using an evacuation prediction model, wherein the evacuation risk data refers to a regional congestion risk of the monitoring region at a future time point, on the premise that the candidate emergency parameter is used to evacuate personnel in the monitoring region, and the evacuation prediction model is a machine learning model; and determining the emergency evacuation parameter based on the evacuation risk data, wherein the emergency evacuation parameter includes a device configuration parameter, a traffic control parameter, and a traffic guidance parameter, and the device configuration parameter is used to control a transportation speed of an associated transportation device; and
transmitting an emergency control signal to an emergency evacuation device deployed in the monitoring region via an emergency supervision sensing network platform based on the emergency evacuation parameter, to control an opening interval of a channel gate based on the traffic control parameter, and to control a display content of an electronic display board based on the traffic guidance parameter, wherein the display content includes at least one of a display color, an evacuation direction, or an evacuation route.

7. The method according to claim 6, wherein the method further comprises:
determining predicted pedestrian flow data at the future time point based on the regional monitoring data, the regional specification feature, and external environmental data using a feature prediction model, wherein the feature prediction model is a machine learning model;
determining predicted risk data based on the predicted pedestrian flow data; and
determining an updated regional congestion risk based on the predicted risk data and the regional tolerance.

8. The method according to claim 7, wherein the determining the predicted pedestrian flow data at the future time point based on the regional monitoring data, the regional specification feature, and the external environmental data using the feature prediction model includes:
acquiring an activity pattern feature based on emergency monitoring data; and
determining the predicted pedestrian flow data at the future time point based on the activity pattern feature, the regional personnel feature, the regional monitoring data, the regional specification feature, and the external environmental data using the feature prediction model.

9. The method according to claim 6, wherein the determining the emergency evacuation parameter based on the regional congestion risk includes:
determining a similar region of the monitoring region based on region function data, a region layout feature, and region object data; and
determining the emergency evacuation parameter based on the similar region and the regional congestion risk.

10. The method according to claim 6, wherein an input of the evacuation prediction model includes the regional personnel feature and an activity pattern feature.

11. A non-transitory computer-readable storage medium, storing computer instructions, wherein when read and executed by a computer, the computer instructions cause the computer to perform a method for smart city crowd evacuation based on an Internet of Things (IoT) large model, wherein the method is executed by an emergency supervision management platform for smart city crowd evacuation based on the IoT large model, and the method comprises:
acquiring regional monitoring data based on an emergency supervision sensing control platform through a monitoring device deployed in a monitoring region;
determining a regional congestion risk based on the regional monitoring data, including: determining a regional personnel feature based on the regional monitoring data; determining a regional tolerance based on a regional specification feature and obstacle distribution data; determining first correction data by querying a correction table based on the regional personnel feature; determining an initial regional congestion risk by querying a preset congestion risk table based on the regional tolerance and the regional monitoring data; and determining the regional congestion risk by multiplying the first correction data by the initial regional congestion risk, wherein the initial regional congestion risk is a regional congestion risk before correction, the regional personnel feature includes an age distribution of people in the monitoring region, a count and positions of special groups, and a count and positions of people with luggage, and the special groups include people with mobility impairments and pregnant women;
in response to the regional congestion risk satisfying an evacuation condition, determining an emergency evacuation parameter based on the regional congestion risk, including: acquiring a candidate emergency parameter; determining evacuation risk data corresponding to the candidate emergency parameter based on the candidate emergency parameter, the regional congestion risk, the regional specification feature, and the regional personnel feature using an evacuation prediction model, wherein the evacuation risk data refers to a regional congestion risk of the monitoring region at a future time point, on the premise that the candidate emergency parameter is used to evacuate personnel in the monitoring region, and the evacuation prediction model is a machine learning model; and determining the emergency evacuation parameter based on the evacuation risk data, wherein the emergency evacuation parameter includes a device configuration parameter, a traffic control parameter, and a traffic guidance parameter, and the device configuration parameter is used to control a transportation speed of an associated transportation device; and
transmitting an emergency control signal to an emergency evacuation device deployed in the monitoring region via an emergency supervision sensing network platform based on the emergency evacuation parameter, to control an opening interval of a channel gate based on the traffic control parameter, and to control a display content of an electronic display board based on the traffic guidance parameter, wherein the display content includes at least one of a display color, an evacuation direction, or an evacuation route.
